(19) United States
(12) Patent Application Publication
(10) Pub. No.: US 2002/0059364 A1
(43) Pub. Date: May 16, 2002

(54) CONTENT CERTIFICATION

(76) Inventors: CHRISTOPHER M COULTHARD, ARLINGTON, MA (US); SCOTT C MCLEOD, CHELMSFORD, MA (US); PETER D NORMAN, ARLINGTON, MA (US); KEVIN WILLOUGHBY, FRAMINGHAM, MA (US); ROD G HODGMAN, BOXBOROUGH, MA (US)

Correspondence Address: GOODWIN PROCTER LLS, 7 BECKER FARM ROAD, ROSELAND, NJ, 07068, US

(21) Appl. No.: 09/248,370

(22) Filed: Feb. 8, 1999

(51) Int. Cl. G06F 15/16

(52) U.S. Cl. 709/203

(57) ABSTRACT

A method of processing content includes storing verification information corresponding to certified content at a first computer and receiving a verification request corresponding to content from a second computer. The method also includes determining verification information for the content corresponding to the verification request and comparing the determined verification information with the stored verification information.

### BACKGROUND OF THE INVENTION

The Internet and the World Wide Web have made information dissemination fast, easy, and cheap. Postings from both businesses and individuals have contributed to the wealth of available information. Unfortunately, the available information is sometimes of dubious value. For example, in 1998 a news agency accidentally posted a pre-written obituary of Bob Hope on its Web-site. Congress held a moment of silence in his honor. The report of Mr. Hope's demise, however, was greatly exaggerated. Other Internet postings have been less innocuous such as the accidental pre-release of economic data by the U.S. Bureau of Labor and Statistics.

In addition to accidental postings, some information available on the Internet, purporting to be from official sources, includes intentionally fabricated data or malicious statements. As a result, users tend to be somewhat skeptical of information accessed from the Internet. Additionally, some businesses, wary of potential liability or embarrassment, have begun to err on the side of safety and withhold information from Internet publication. These factors combine to reduce the effectiveness of the Internet as a communication medium.

### SUMMARY OF THE INVENTION

In general, in one aspect, a method of processing content includes storing verification information corresponding to certified content at a first computer and receiving a verification request corresponding to content from a second computer. The method determines verification information for the content corresponding to the verification request and compares the determined verification information with the stored verification information.

Embodiments may include one or more of the following features. The method may feature receiving content certification criteria that can be used to determine whether content should be certified. The content certification criteria can be a list of required approval or programmed logic. The method may also feature storing certification information (e.g., a type of certification granted, entities approving certification, and when the content was certified). The verification information can include information derived from the content such as at least one hash key.

The verification request can include a URL. This can enable determination of verification information by collecting content from the URL included in the verification request.

The verification request can include content. This can enable determination of verification information by determining verification information for the content included in the verification request.

The verification request can include verification information. This can enable determination of verification information by merely using information included in the verification request.

Receiving a verification request may be produced by user interaction with a certification indicator, for example, a certification indicator included in the content.

The certification indicator can include a graphic image having associated instructions that produce a verification request. The method may further include transmitting certification information to the second computer.

The content may include graphics, text, animation, sound, and instructions. The content may form a web-page. The comparing may include issuing verification requests to connected certification servers.

In general, in another aspect, a method includes presenting an indication that content is certified and receiving user input requesting certification verification of the content. The method further includes transmitting a certification verification request to a certification server and receiving information indicating whether the content has actually been certified.

Embodiments may include one or more of the following features. Presenting an indication may include presenting a user interface control. The method may further include displaying information included in the information received (e.g., content authorship, revision number, expiration date, and type of certification).

Transmitting a certification verification request may include transmitting verification information determined from the content such as one or more hash keys. Transmitting a certification verification request may include transmitting information included in the content. Transmitting a certification verification may include transmitting a URL.

In general, in another aspect, a method of controlling content distribution includes receiving certification criteria for content to be distributed, identifying content to be distributed, and determining whether the identified content satisfies the received certification criteria.

Embodiments may include one or more of the following features. Identifying content may include receiving a request for content at a server. Identifying content may include collecting content from a set of locations. Determining whether the content satisfies the certification criteria may include identifying at least one digital signature associated with the content and/or determining verification information (e.g., a hash key) for the content.

Advantages may include one or more of the following features. The techniques provide users with a simple and intuitive method of verifying that content (e.g., a web-page) has been certified by an organization. Verification can be a mouse-click away when content includes a certification indicator. Underlying mechanisms protect the verification process from falsification and tampering. These mechanisms enable users to trust the authenticity of displayed content.

The techniques also enable an organization to carefully define certification procedures that content must undergo before certification and distribution. Automating these certification procedures enables an organization to vigilantly control the quality and reliability of information provided.

Different implementation architectures permit distribution of certification functions across different computers and potentially speeding certification verification.

Other advantages of the invention will become apparent in view of the following description, including the figures, and the claims.

### BRIEF DESCRIPTION OF THE DRAWINGS

FIG. 1 is a screenshot of content that includes a certification indicator.

FIG. 2 is a screenshot of information that verifies content certification.

FIG. 3 is a flowchart of a process for certifying content.

FIG. 4 is a flow diagram of a certification and certification verification of content.

FIG. 5 is a flowchart of a certification procedure.

FIG. 6 is a block diagram of a certification scheme.

FIGS. 7A and 7B are screenshots of user interfaces for submitting content for certification.

FIG. 8 is a flow diagram of content certification.

FIG. 9 is a flowchart of content certification.

FIG. 10 is a diagram of information stored at a certification server.

FIG. 11 is a diagram of digital signature blocks issued for certified content.

FIG. 12 is a block diagram of a certification server and certified content.

FIGS. 13-14 are flowcharts of processes for monitoring posted content.

FIGS. 15-16 are screenshots of graphical user interfaces that include certification indicators.

FIG. 17 is a diagram of a certification verification request.

FIGS. 18-22 are flowcharts of processes for certification verification.

FIG. 23 is a flowchart of a process for creating multiple certification servers.

FIG. 24 is a block diagram of a hierarchy of certification servers.

FIG. 25 is a flowchart of a certification verification process using multiple certification servers.

FIG. 26 is a block diagram of franchisee certification servers.

FIG. 27 is a flowchart of a process for transmitting content to a franchisee server.

FIG. 28 is a flowchart of a process for updating content offered by a franchisee server.

### DESCRIPTION OF THE PREFERRED EMBODIMENTS

Introduction

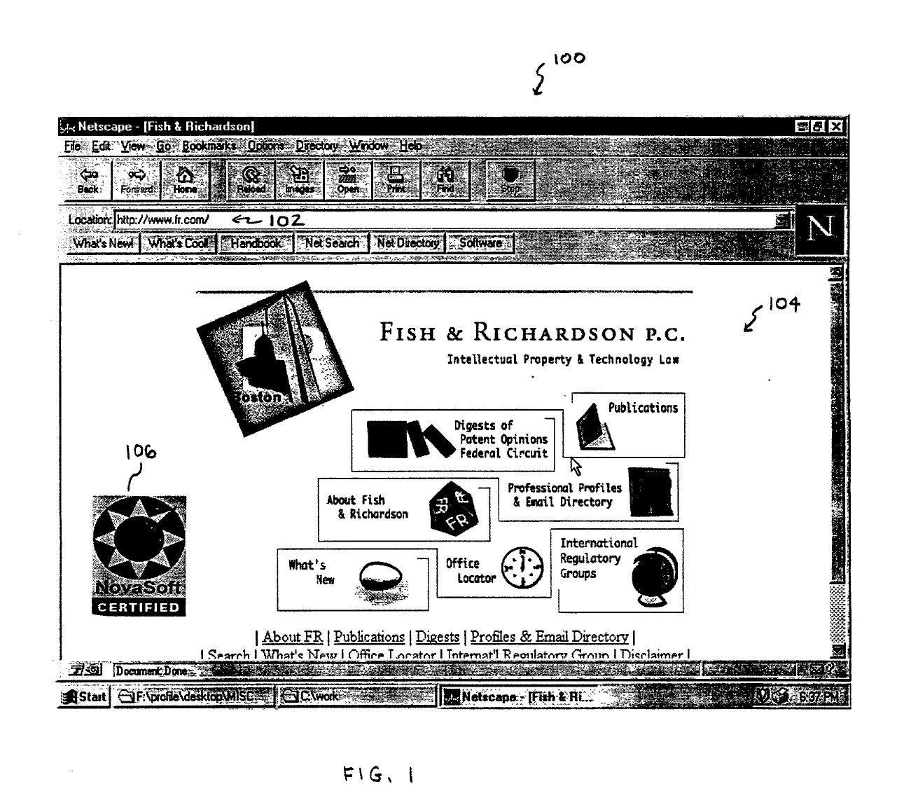

Referring to FIG. 1, a browser's graphical user interface 100 (e.g., Netscape™ Navigator™) presents content 104 provided by a resource (e.g., a file) at a URL (Universal Resource Locator) 102. The content 104 can include graphics, text, animation, sound, instructions (e.g., Java Applets), etc. A URL 102 can refer to a location on a remote computer that stores the content 104 as data and presentation instructions. The presentation instructions and data can be in a variety of formats such as HTML (HyperText Markup Language), XML (Extensible Markup Language), PDF (Portable Document Format), JPEG (Joint Photographic Experts Group), and MPEG (Moving Picture Experts Group). When a browser requests content 104 from a URL 102 resource, a remote computer providing the resource can transmit the content 104 to a browser for presentation. As shown, the browser is an independent application, however, other applications (e.g., an e-mail program, a word processor, or a spread-sheet) can incorporate functions traditionally performed by the browser.

As shown in FIG. 1, the browser display 100 includes a certification indicator 106. The indicator 106 provides a simple method of ensuring that the content 104 presented has undergone a certification process. Content 104 may include one or more certification indicators 106 (e.g., “Certified by the Legal Department” and “Certified by the Marketing Department”). As shown, the indicator 106 is a user interface control that has a graphic image, however, different implementations can present the control to a user as text, sounds, or by using other user interface techniques. User selection of the indicator 106 (e.g., using a mouse or other pointing device to click on the graphic image) initiates a certification verification process that can confirm that the content presented is the same content that has undergone the certification process claimed by the certification indicator 106.

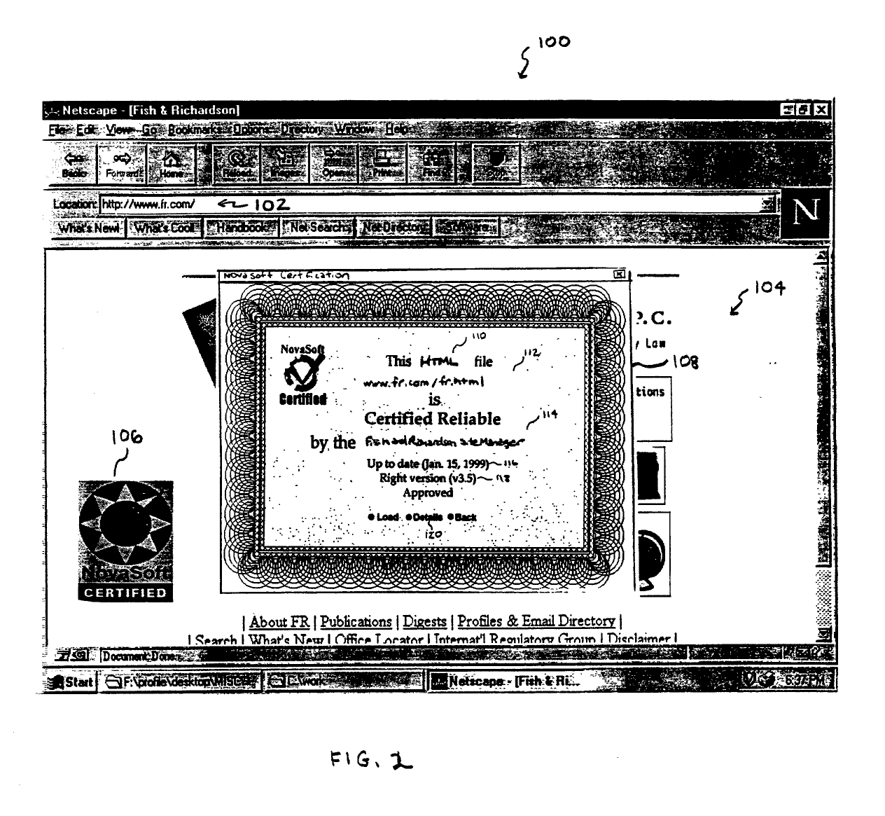

Referring to FIG. 2, the certification verification process can produce a window 108 that includes a display of information describing the content's 104 certification such as the entities that have approved the content 114, when such approval occurred 116, the version number 118, etc. Other user interface techniques can notify a user of certification. For example, a user interface can play voice data provided by a person who certified the data (e.g., “This web-page was approved by John Doe on Feb. 8, 1999”).

FIGS. 1 and 2 illustrate a simple and intuitive interface that ensures presented content is genuine. Underlying mechanisms protect the verification process from being falsified or mimicked. These mechanisms enable users to trust the authenticity of displayed content and provide web administrators with a tool for controlling content offered by a site.

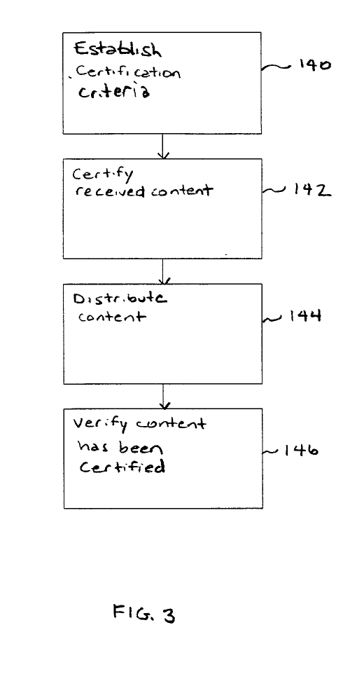

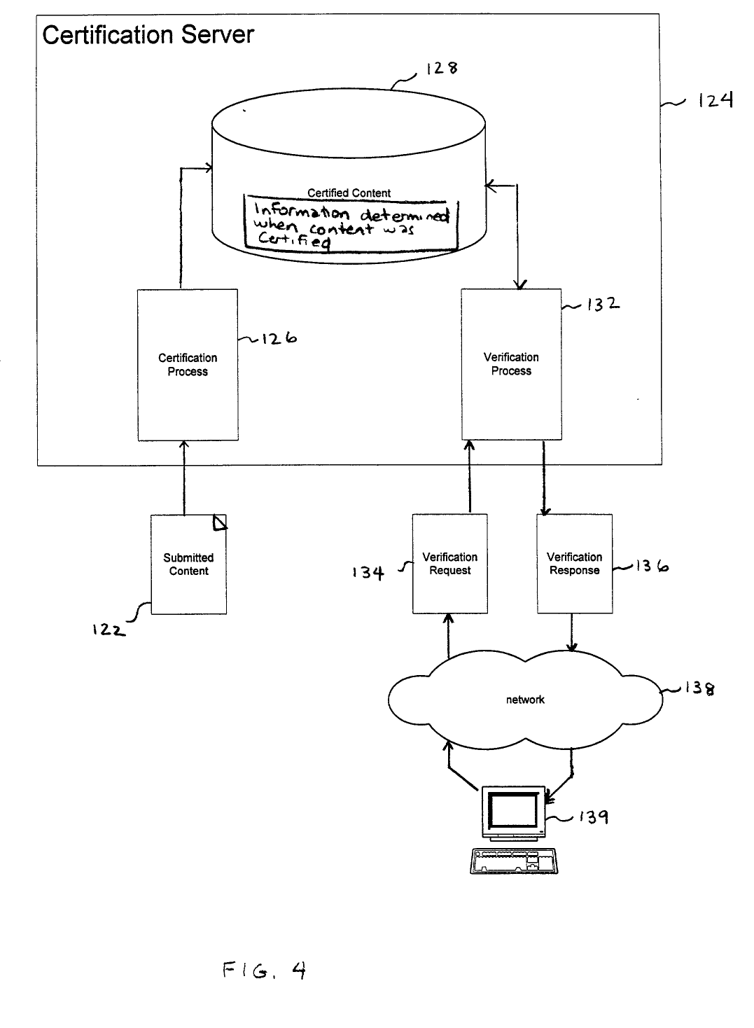

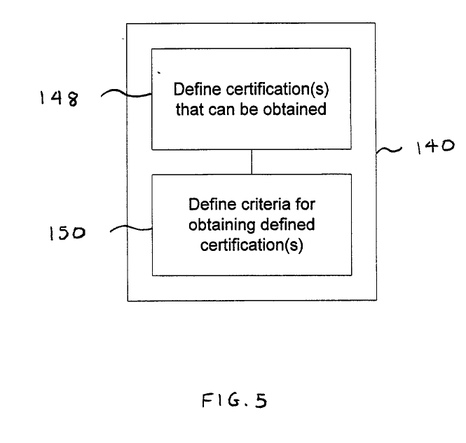

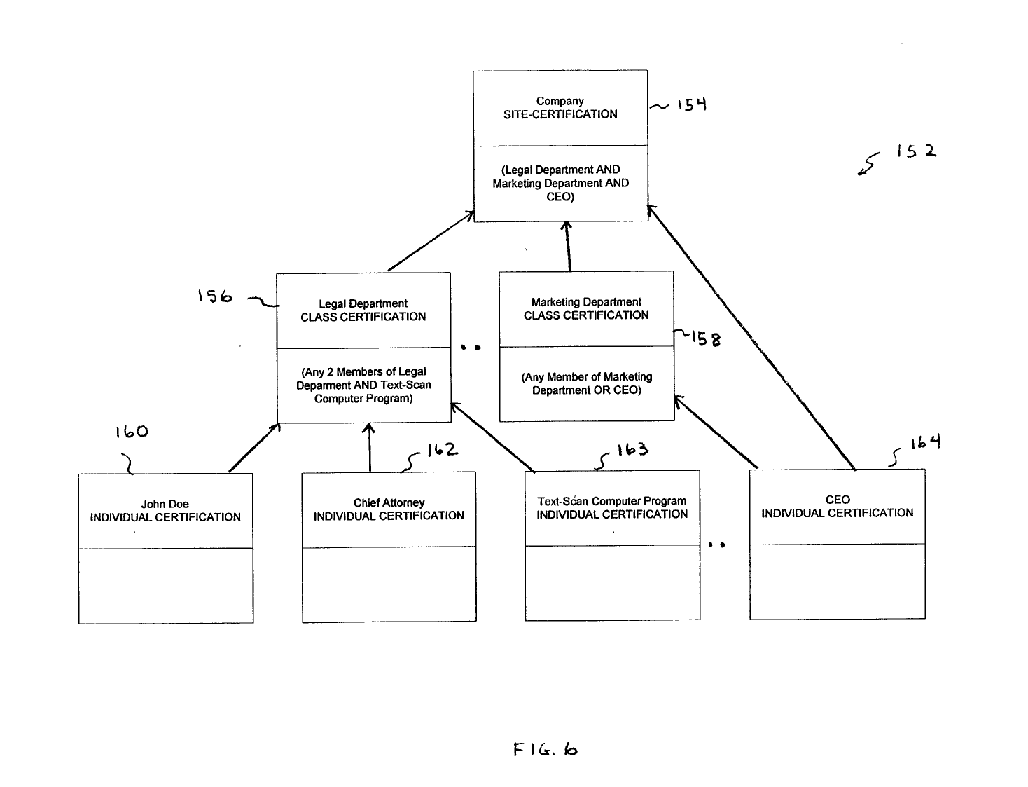

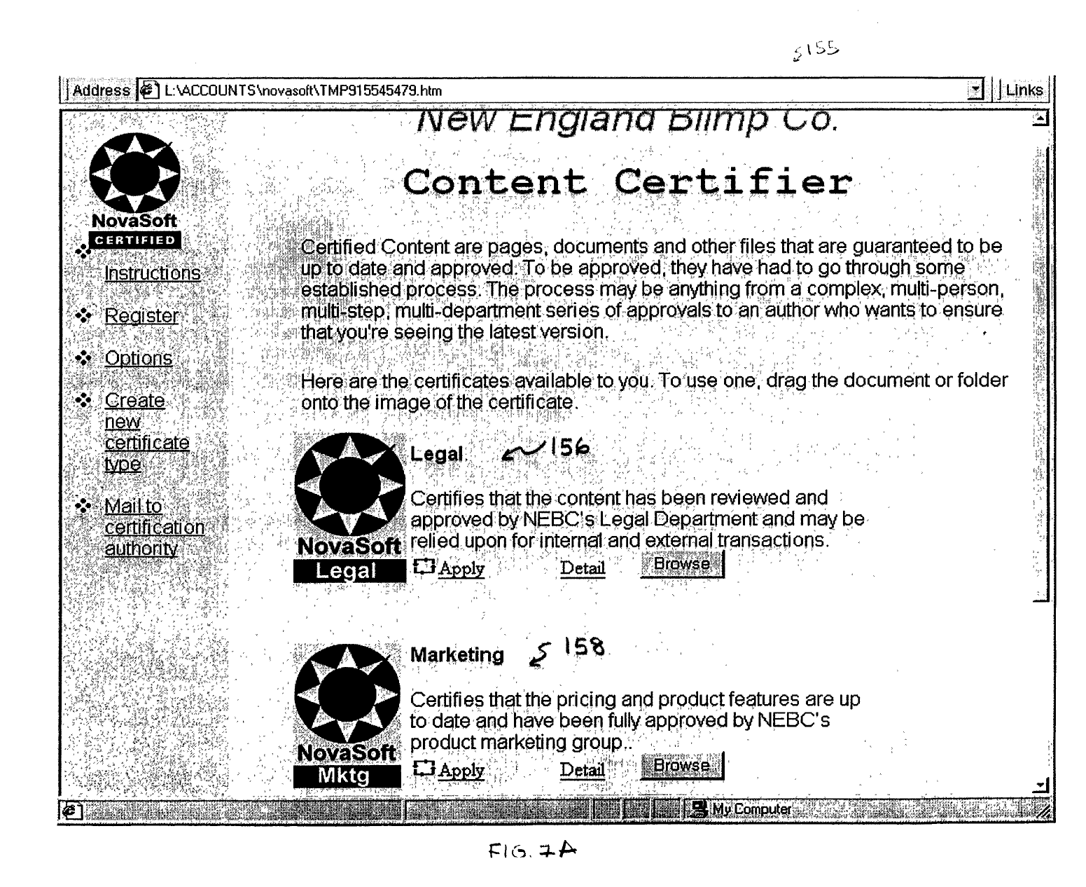

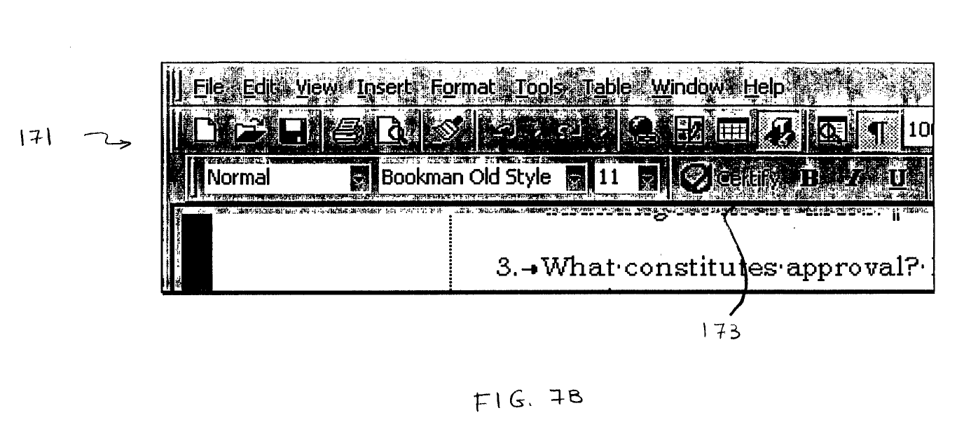

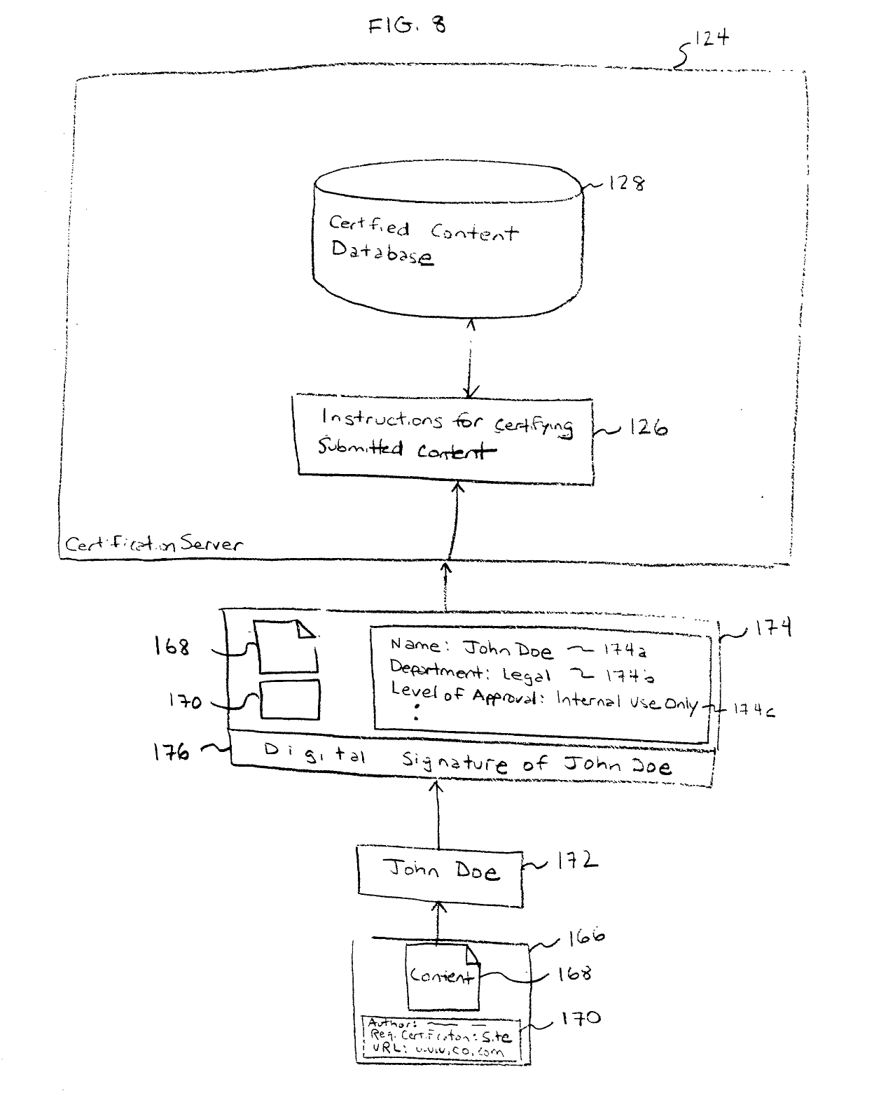

Referring to FIG. 3, a certification process permits an entity (e.g., business, organization, or individual) to establish certification criteria 140. For example, a business can list employees that must approve submitted content 142 before it receives certification. After certification and distribution 144 of content (e.g., by posting the content on an Intranet, Extranet, or Internet site or e-mailing the content to recipients), mechanisms can verify 146 that the content presented to a user satisfies the criteria required for certification 140 and has not been altered since certification. The process can then present certification information such as the entities that approved the content. Thus, users can view unforgeable information detailing the certification process undergone by content prior to distribution.

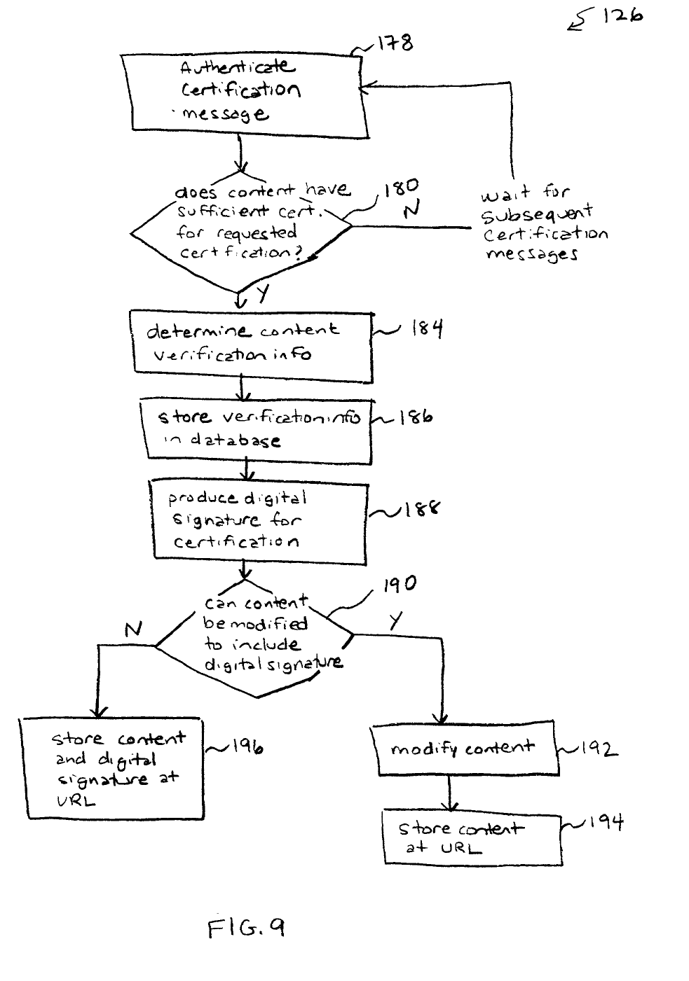

Referring to FIG. 4, an illustrative implementation uses a certification server 124 that includes instructions 126 for certifying submitted content 122. The certification instructions 126 can enforce certification criteria (e.g., all content must be approved by the legal department). The certification server 124 can include a database 128 for storing verification information determined from certified content. The verification information includes data that identifies the certified content such as a URL, compressed or uncompressed portions of the content, and/or an assigned identification number. The verification information may also include one or more hash keys (e.g., an MD5 hash and an SHA hash). A hash key is produced by a one-way function and typically requires little storage space (e.g., 160-bits). Hash keys are nearly guaranteed to be unique for any given content.

The database 128 can also store certification information such as the type of certification (e.g., the Legal Department), entities certifying the document, when certification occurred, when certification expires, the version of the certified content, etc. Certification information and verification information are not mutually exclusive categories. A piece of data may be both certification information and verification information.

As shown in FIG. 4, the certification server 124 also includes instructions 132 for processing requests 134 for certification verification. To verify certification, the instructions 132 can compare the verification information 130 stored during certification to verification information determined for the content being verified. A match indicates the content has undergone a certification process and has not been altered since. The certification server 124 can transmit information confirming certification of the content in question, for example, by dynamically generating HTML instructions that includes certification information. An administrator can revoke certification by simply deleting or altering information in the database 128.

Defining a Certification Procedure

Referring to FIG. 5, an organization can use an interface to define different certifications 148 and criteria for granting the certifications 150 to submitted content. The criteria can include a simple list of employees that must approve submitted content. Criteria can also include programmed logic that tests for satisfaction of different conditions. The ability to program criteria enables a business to define certification processes that reflect a commitment to distributing thoroughly reviewed content.

Referring to FIG. 6, one possible certification scheme 152 uses different certification levels. As shown, the levels include site-wide certification 154, class certification 156-158, and individual certification 160-164. Each defined certification can include its own granting criteria. For example, to obtain site-wide certification, content must first receive certification from the Legal Department 156, the Marketing Department 158, and the company's CEO 164. Similarly, to receive Legal Department certification 156, at least two members of the legal department and a text-scanning program that looks for certain phrases must approve the content. As shown, the certification criteria can include different levels of abstraction. For example, instead of requiring certification from a particular named person, certification criteria can be more abstractly expressed, for example, as a role 162 (e.g., chief attorney) within an organization. This enables certification to continue as different persons fill positions.

The criteria for certification may include different levels of approval. For example, Marketing Department certification 158 may only require that each member of the marketing department receives content for review, while Legal Department certification may require that each member affirmatively indicates approval of the content. Additionally, certification may be sought for internal (e.g., on an Intranet) or external publication (e.g., on the Internet). The criteria for external publication can be stricter than the criteria for internal publication.

The scheme 152 shown forms a hierarchy between the different certification levels 154-164. The hierarchical structure is a function of the defined criteria and is not an inherent characteristic of schemes having different certifications.

Content Certification

Referring to FIGS. 7A and 7B, easy-to-use graphical user interfaces shield users from the mechanics of submitting content for certification. For example, as shown in FIG. 7A, a user can submit content via a password protected web-page by dragging-and-dropping content onto one or more defined certification controls 156, 158. A control 156, 158 receiving the content can prepare and transmit a certification request indicating the content and the certification desired. The certification controls 156, 158 presented can vary depending on the person submitting content. Alternatively, as shown in FIG. 7B, an application toolbar 171 can include a “Certify” button 173. Selecting the button 173 can prepare and transmit a certification request for a document. The user interfaces of FIG. 7A and 7B are merely illustrative and other differently designed user interfaces could easily provide similar functions. Additionally, a system need not provide a graphical user interface at all, for example, by using e-mail to submit content for certification.

Referring to FIG. 8, a certification request 166 includes content 168 (or a reference to content) submitted for certification and other information 170 such as the certification desired (e.g., site-wide certification or Legal Department certification), the content authors, and a proposed URL. The request 166 can also include information such as a revision number, content keywords, title, etc. (not shown).

SSL (Secure Socket Layer), S-HTTP (Secure Hypertext Transfer Protocol), and other secure communications techniques can protect submitted content from tampering during transmission. Additionally, a request 166 can include one or more digital signatures (not shown) that enable a receiving computer to authenticate the source of the message. While these features enhance security and protect content from tampering en route to the certification server, the certification process does not require these measures.

The certification server 124 can process certification requests. The server 124 can distribute submitted content to individuals 172 that could potentially provide approval needed for certification. For example, the server 124 can distribute content to all the members of the Legal Department when a request is made for Legal Department certification. Workflow software, e-mail daemons, and other techniques, potentially executing on computers other than the certification server, can also distribute content to individuals for certification.

As shown in FIG. 8, after an entity 172 receives and reviews submitted content 168, the entity 172 can notify the certification server 124 of its approval by sending a certification message 174. The certification message 174 can include the submitted content 168 and other information 170 included in the certification request. The message can also include information 174 that describes the person transmitting the certification message 174a, the type of certification granted 174b (e.g., a person can have the capacity to certify content for both the marketing and the legal departments), and a level of approval 174c (e.g., “for internal use only” or “for publication on the Internet”). The certification message 174 may also include a digital signature 176 (e.g., a Verisign™/W3C X.509 digital certificate) belonging to the individual submitting the certification message 174 or may include information used by other authentication techniques such as biometric authentication. As shown in FIG. 8, the certification server 124 processes received certification messages 174 with certifying instructions 126.

Referring to FIG. 9, in one implementation, the certifying instructions 126 authenticate 178 a certification message to ensure the person claiming to have approved submitted content was, in fact, the person who produced the certification message 174. After authentication 178, the instructions 126 can determine 180 whether the certification message received satisfies the criteria for the certification requested. For example, the instructions 126 can determine whether John Doe's 172 certification message 174, alone or in combination with previously received certification messages, is sufficient to obtain Legal Department certification. If the received certification message 174 does not satisfy the criteria, the instructions 126 can store the received certification and await further certification messages. The process may store a hash for submitted content awaiting further certification to ensure that subsequent certification is for the same content as the certification already received. The process 126 can also attempt to certify any links or other objects referenced by the content (e.g., using W3C's manifest protocol).

If the received certification message satisfies certification criteria, the instructions 126 can determine 184 verification information from the certified content or other information provided. For example, the instructions 126 may compute one or more hash keys from the certified content. In general, the verification information can include any information that can be used to identify the certified content.

After storing the content's certification and verification information in the database 186, the instructions 126 can produce a digital signature 188 (e.g., a W3C DSig (Digital Signature Group) compliant signature) for the content 188. The digital signature 208 can include the computed hash 210, the content's URL 212, or any other verification or certification information (not shown).

After producing the digital signature 190, the instructions 126 can determine 190 whether the content can be dynamically modified 192 to include the digital signature. For example, HTML and XML permit dynamic insertion of digital signatures into content (e.g., as header information or as a newly defined tag). Inclusion of the digital signature in the content ensures that the digital signature travels with the content instead of assuming the signature will remain paired with the content during distribution. The instructions 126 can also dynamically modify the content to include one or more certification indicators 106. The instructions 126 can store the digital signature(s) in its database. This prevents database contents from being tampered with as any altered database information will not match the digital signature(s) stored. Finally, the content and digital signature(s) are distributed by storage at a URL 194, 196 or by sending back the certified content to a submitting user for distribution (not shown).

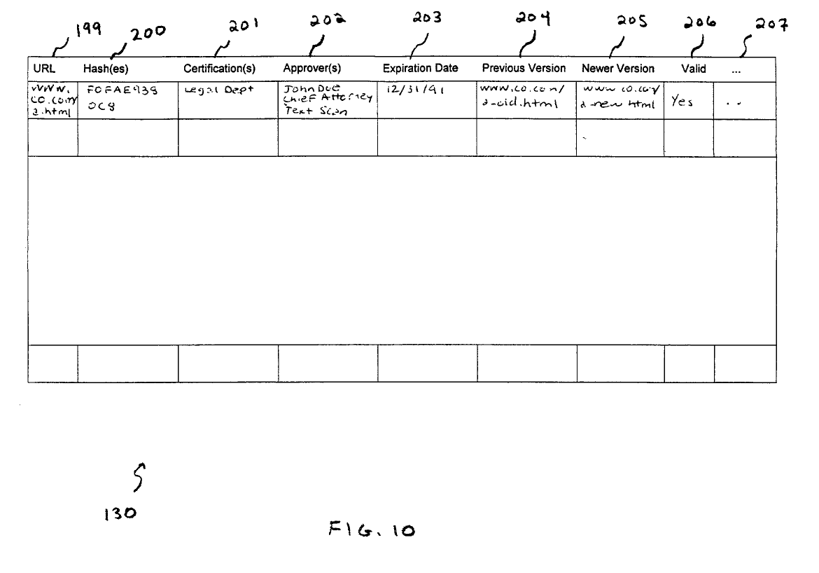

Referring to FIG. 10, the certification server database 130 includes information corresponding to certified content. This information can include a URL 199, one or more hash keys 200, certifications obtained 201, the certifiers 202, and a certification expiration date 203. The database 130 can also include the location (if any) of previous 204 or later 205 content versions. When the certification server 124 receives a certification verification request, the server 124 can determine whether a user has attempted to access the most recent version of a document. The server 124 can automatically transmit the more recent version of the document to the user. The database can include a wide variety of other information 207 such as a portion of the content and/or a certification expiration date. The database 130 can also include the location of different translations of content and transmit a translation based on “Preferred Language” data included in a certification verification request.

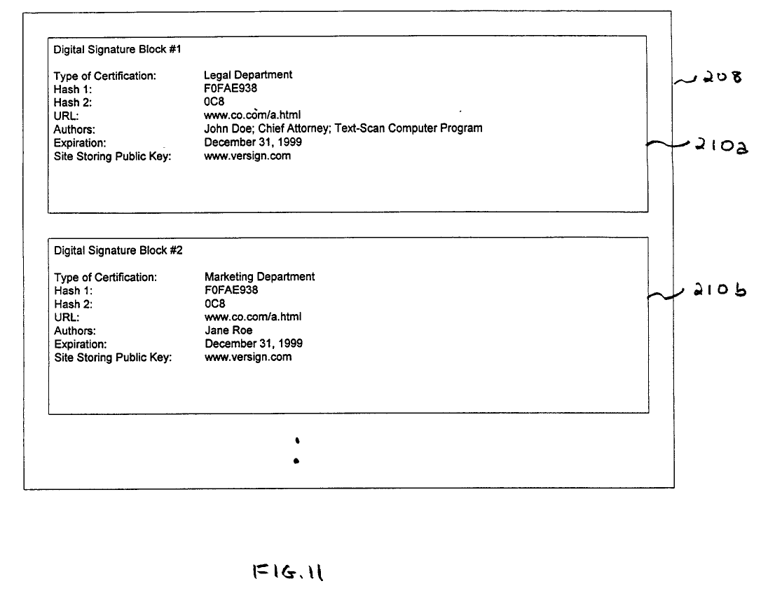

Referring to FIG. 11, after certification, multiple digital signatures 210a, 210b of different certifications may be associated with content. The different digital signatures 210a, 210b may be encrypted and identified by an encapsulating digital signature 208 of the certification server.

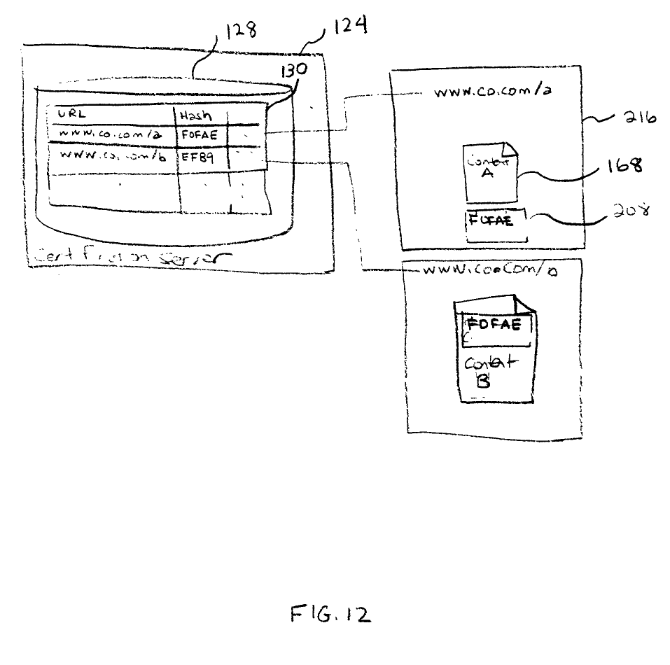

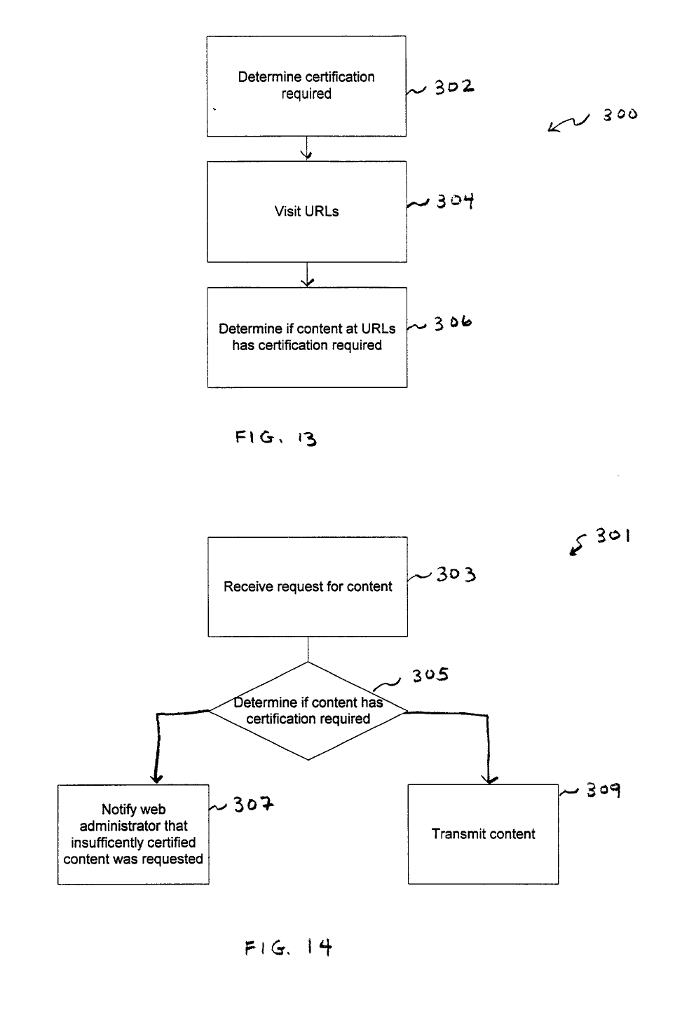

Referring to FIG. 12, after content certification, the certification server 124 database 128 stores the verification information 130 corresponding to certified content 168. Referring to FIG. 13, in addition to verifying certification in response to verification requests, the certification process enables an administrator to enforce minimum certification requirements for posted content. For example, a site might define a policy that requires any content available via the World Wide Web to have certification from both the Legal and Marketing Departments. A process 300 can ensure available content meets these requirements 306 by determining the certification possessed by content at each URL 304 offered by a site. Determining content certification can include identifying and verifying digital signatures stored at the URL. Alternatively, the process 300 can determine verification information of a URL and compare the determined verification information with verification information originally stored during certification. Either technique ensures that employees or others do not post content without receiving sufficient certification.

Referring to FIG. 14, enforcing certification criteria can instead occur at a web-server processing content requests. After receiving a request for content 303, the web-server can determine 305 if the requested content has the certification required for transmission 309. If not, the web-server can notify the web-server administrator 307 that insufficiently certified content has been requested indicating that a link or directory has indicated the presence of the content on the server. This enables the administrator to quickly find content that should not be posted at the site. The web-server can also store information that specifically disavows certification for particular content.

Certification Verification

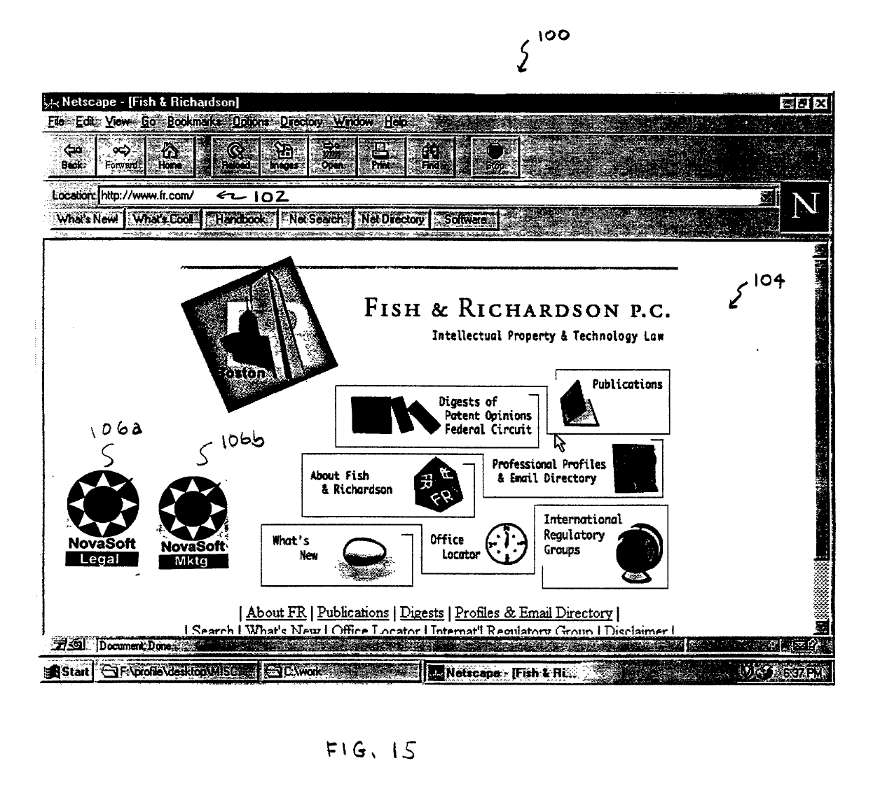

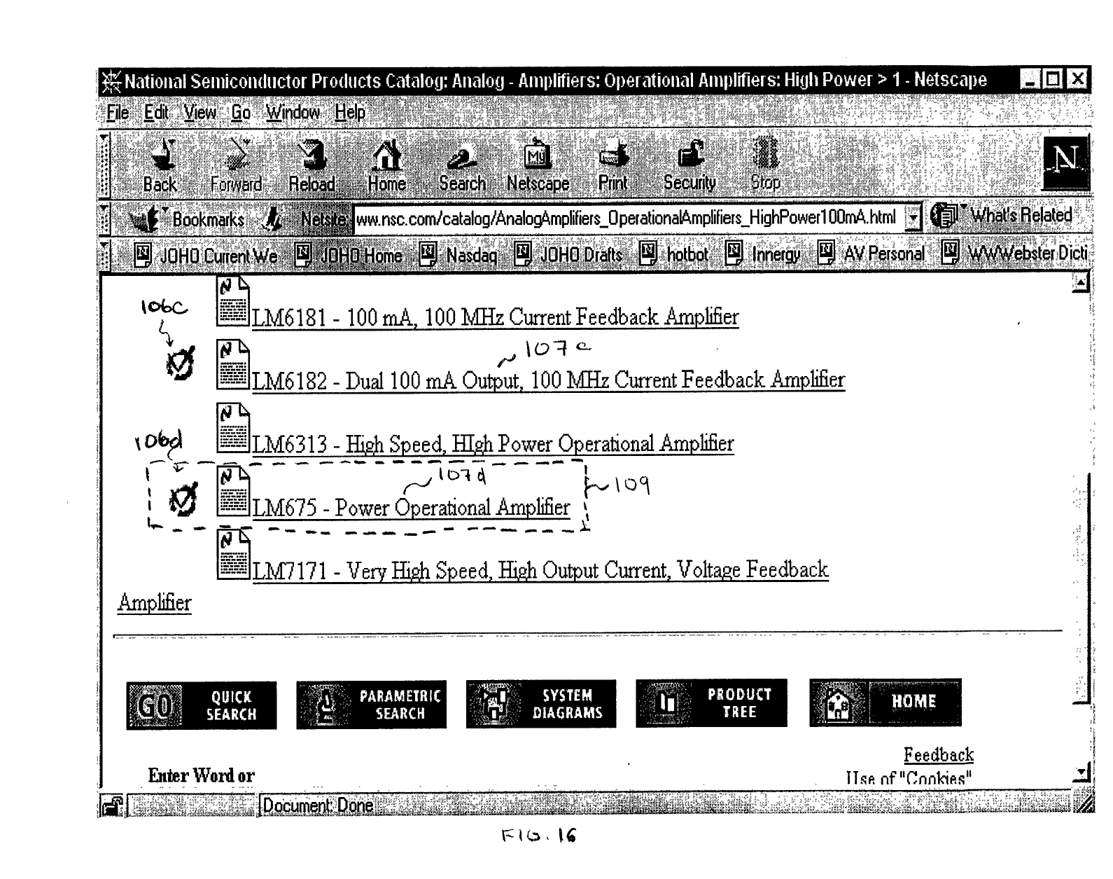

Referring to FIG. 15, in one implementation, certification instructions dynamically modify certified content to include one or more certification indicators 106a, 106b. Referring to FIG. 16, certification indicators 106c, 106d may instead be paired with a listing of certified URLs 107c, 107d, for example, produced by a search engine. The certification indicators 106a, 106b may be packaged (e.g., included in the same ActiveX control or Java applet) with a corresponding URL 107a, 107b to prevent a certification indicator 107a, 107b from accidental or intentional pairing with a different, potentially uncertified, URL. Selecting an indicator 106, 106a, 106b can initiate a certification verification process.

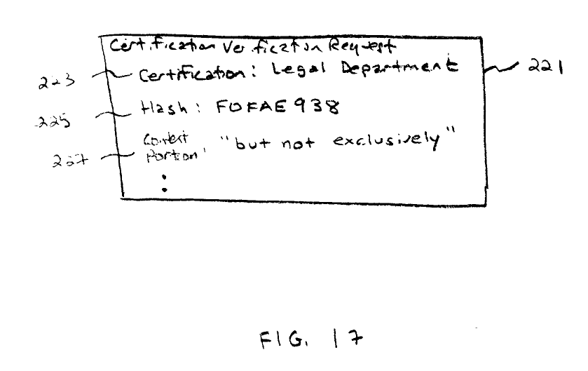

Referring to FIG. 17, initiation of the certification verification process can include preparing and transmitting a certification verification request 221 to a certification server. The request 221 can include, for example, the certification claimed by a certification indicator 223 and verification information 225 determined from the content presented. The request may be encrypted to prevent analysis. The request 221 may also include a portion of the content presented 227 for comparison to similar information stored in the certification server. This can make “door-knob rattling” more difficult. That is, people wishing to find a valid hash key cannot simply submit request after request with different hash keys until one works. The request 221 can include other information such as the URL of the content, etc.

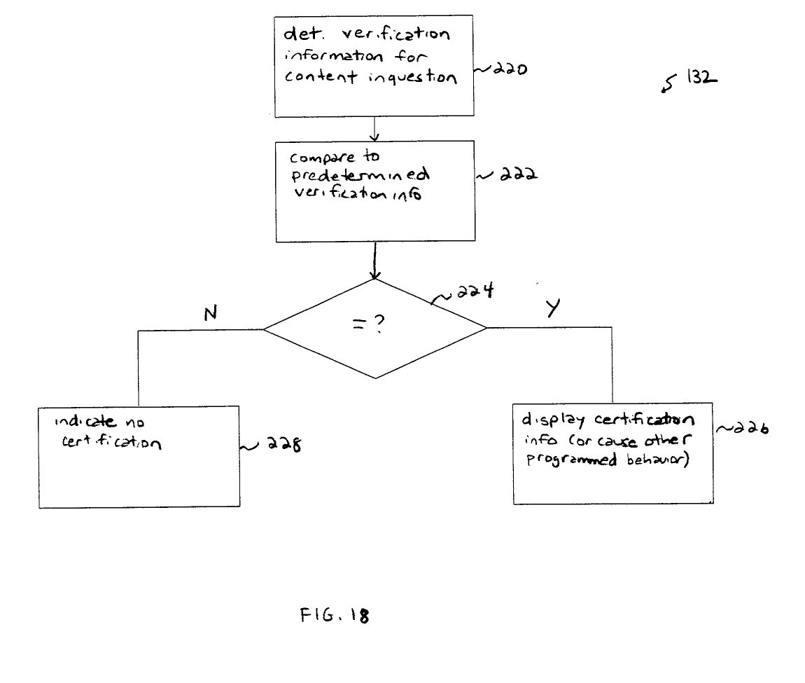

Referring to FIGS. 18-22, certification verification can be implemented in any number of ways. The techniques used to verify certification can depend in part on functions provided by the browser (or other application) presenting the content in question. For example, older browsers may not accept or be able to process digital signatures. Additionally, a browser may not include instructions for determining verification information (e.g., the ability to compute an MD5 hash from presented content).

The different certification verification techniques, nevertheless, share a general process 132. First, the procedures 132 determine verification information (e.g., computing a hash or extracting verification information from a digital signature) for content 220 being verified. When the determined verification information matches 222, 224 the verification information originally determined during certification, the procedures 132 can conclude that the content satisfies certification criteria and has not been altered since certification. The procedures 132 may also check to ensure certification has not expired and that a more recent version of the document has not been certified.

After verifying certification, the procedures 132 can cause display of verification and/or certification information such as the entities that certified a document, when certification occurred, etc. Similarly, the procedure 132 can notify a user if verification fails. The procedures 132 can also cause other programmatic behavior to occur in addition to or in lieu of causing a display of information. A small subset of possible implementations follows.

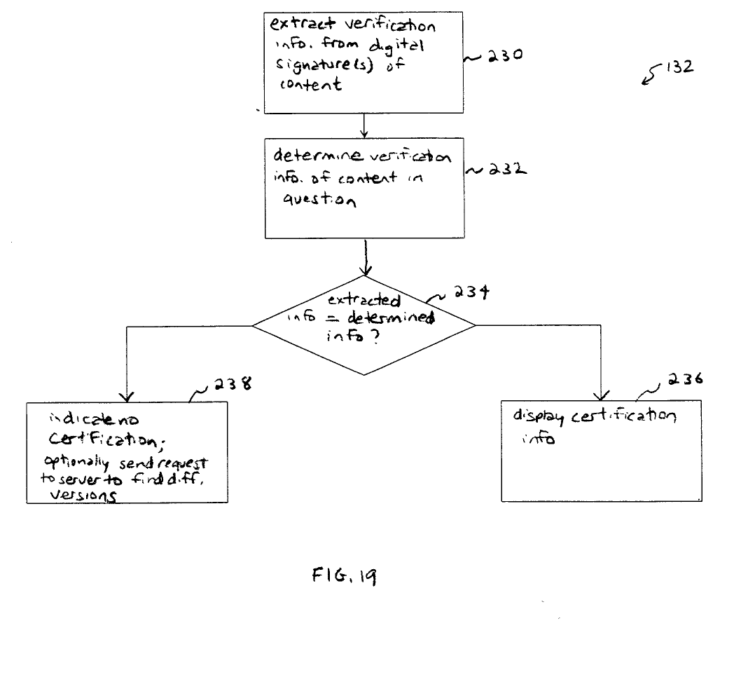

Referring to FIG. 19, if a browser has access to digital signature(s) produced during certification and the ability to determine verification information from content, the browser can extract the verification information from the digital signature(s) 230, determine the verification information of the content in question 232, and compare the two 234. A match verifies the claimed certification 236. This method does not require access to the certification server for certification verification. However, access to the certification server enables a user to determine if the content remains certified or has been replaced by a new version.

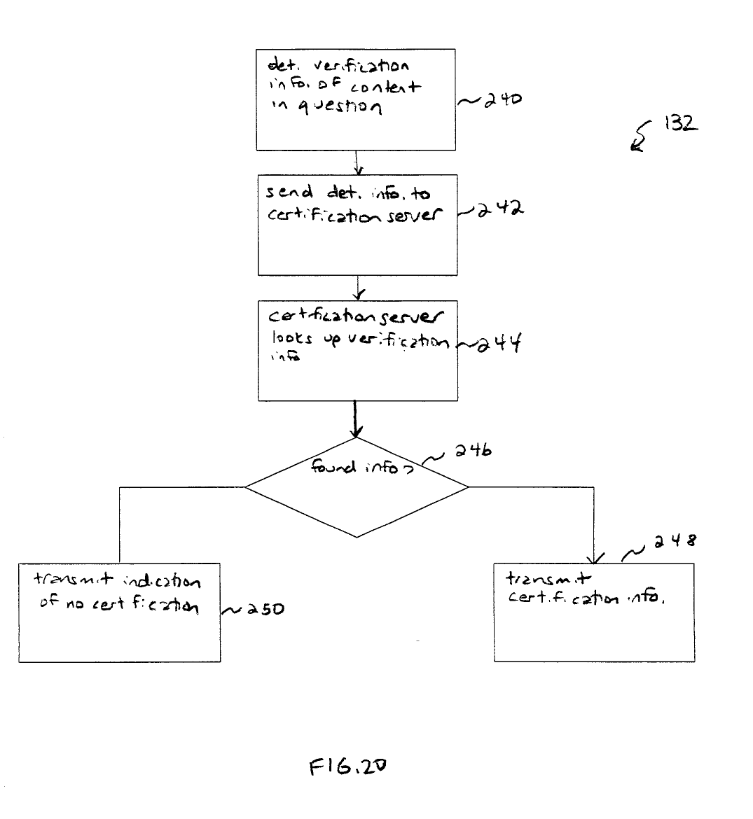

Referring to FIG. 20, if a browser does not have access to digital signature(s) produced during certification but has the ability to determine verification information, the browser can determine the verification information for the content 240 (e.g, compute a hash) and send the determined verification information to the certification server 242. The certification server can compare 244, 246 the determined verification information with the verification information originally determined during certification. Again, if the two match, the content's certification has been verified.

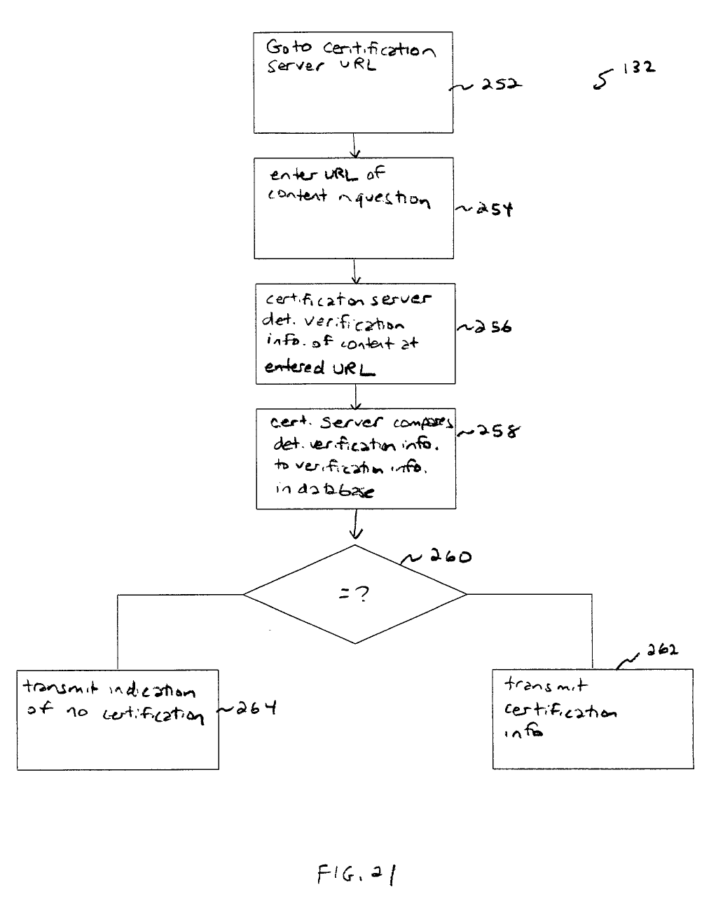

Referring to FIG. 21, in some cases, content may not display a certification indicator. A user may, nevertheless, determine whether the content received certification. In one implementation, the user can visit a certification server web-site 252 and enter a URL for verification 254. Instructions on the certification server can collect the content provided by the resource at the identified URL, determine verification information from the collected content 256, and compare the determined verification information with stored verification information of certified content. If the instructions find a match, the instructions can transmit verification and/or certification information to the user.

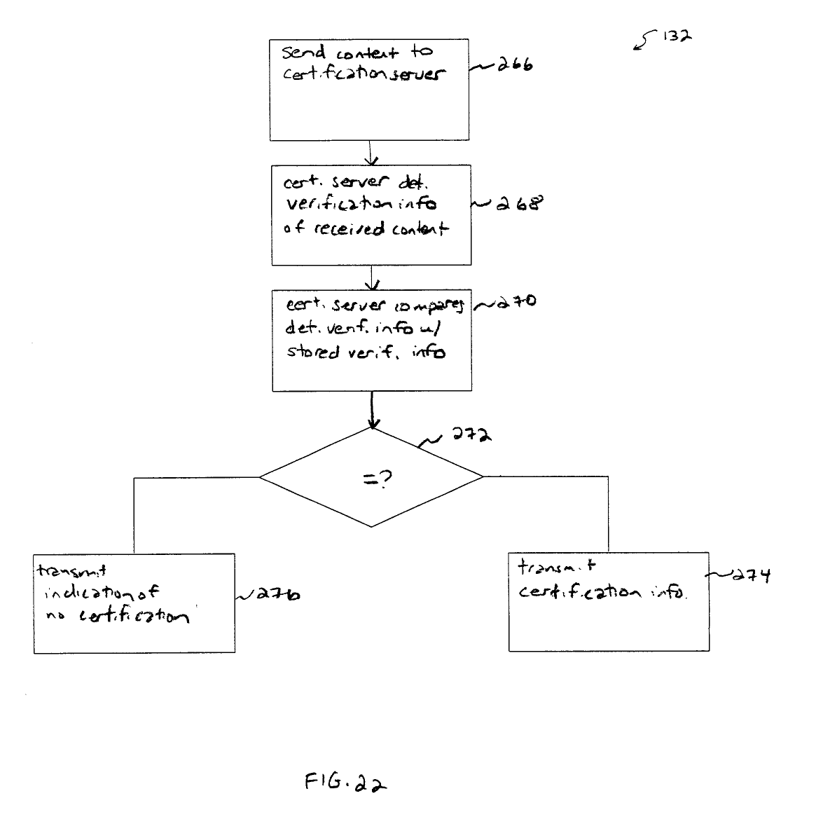

Referring to FIG. 22, in another implementation, a user can simply transmit content in question to the certification server 266 for certification verification. The certification server determines verification information for the content 268 and can compare 270 this verification information with verification information stored in its database. If the certification server identifies a match 272, the certification server can transmit the verification and/or certification information to a user for display 274.

Each of the implementations described above enables a user to quickly determine whether presented content actually comes from an official source. This enables a user to place greater reliance on the presented information and can make the user more likely to return to a site. The implementations also enable a content provider to closely scrutinize and guard the content it distributes.

Multiple Certification Servers

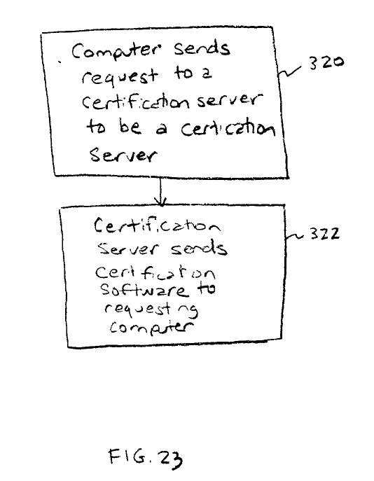

Referring to FIG. 23, the previous discussion described a single certification server. The techniques described can also be used with a network of certification servers. Certification server instructions 322 can be transmitted to different computers requesting 320 the instructions. Such transmission can occur after financial arrangements have been settled. Additionally, authentication may be performed by both the requesting and transmitting servers.

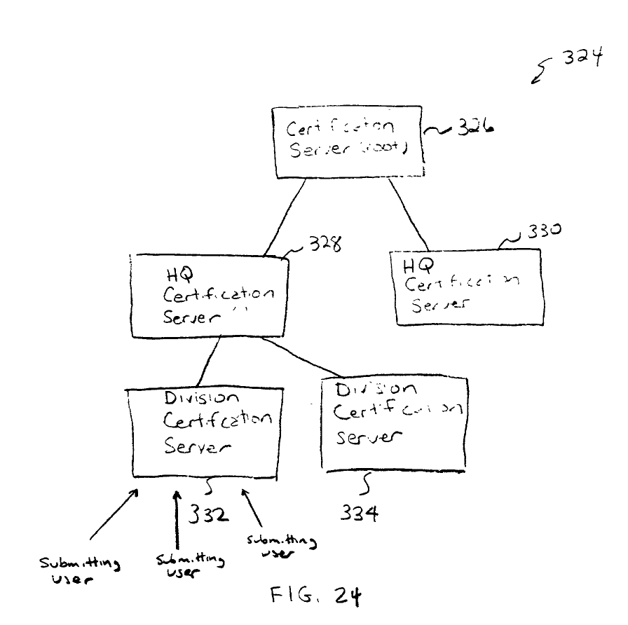

Referring to FIG. 24, certification servers may form a hierarchy 324. For example, a root certification server 326 connects to different company “Headquarter” certification servers. For example, server 328 may belong to Honda while server 330 belongs to General Motors. Each of the headquarter servers may connect to different divisions within a company. For example, server 332 may belong to Honda Motorcycles while server 334 belongs to Honda Automobiles. Although FIG. 24 illustrates a hierarchical relationship, other certification server topologies are possible.

Hierarchically organized certification servers permit distribution of server processing and storage over a number of computers without losing the ability to verify content certified by any of the servers. Additionally, the structure permits hierarchically higher servers to control functions performed by lower servers. For example, a server can control whether another server is itself able to make a request for certification software.

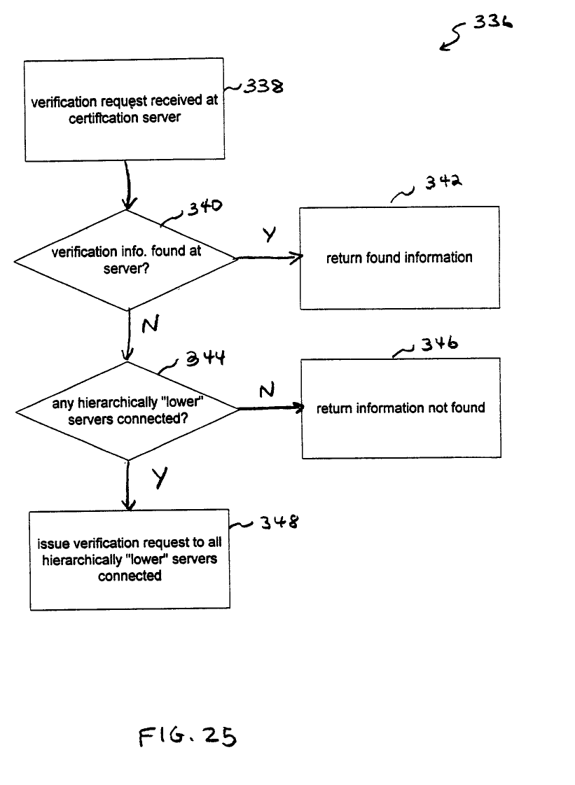

For example, referring to FIG. 25, a recursive procedure 336 can quickly search each certification server to verify certification of content in question. After receiving a verification request 338, a certification server can check its own database 340 for verification information corresponding to the verification request 338. If unable to find the verification information in its own database, the server can issue a verification request to connected servers 344. Eventually, a verification request will reach the server used for certification of the content 342 or all servers will return an indication that no server has certified the content in question.

Other procedures can go up the hierarchy rather than down. For example, when a division certification server 332 receives a certification verification request it cannot provide, the division server 332 can issue a certification verification request to the headquarter's certification server 328.

Franchising

A franchisor (e.g., a corporation or syndicated) often may want to provide content for display on its franchisee's Web-sites. For example, General Motors may want local dealerships to include a national sales advertisement. Additionally, franchisees may want to download certified content describing new products.

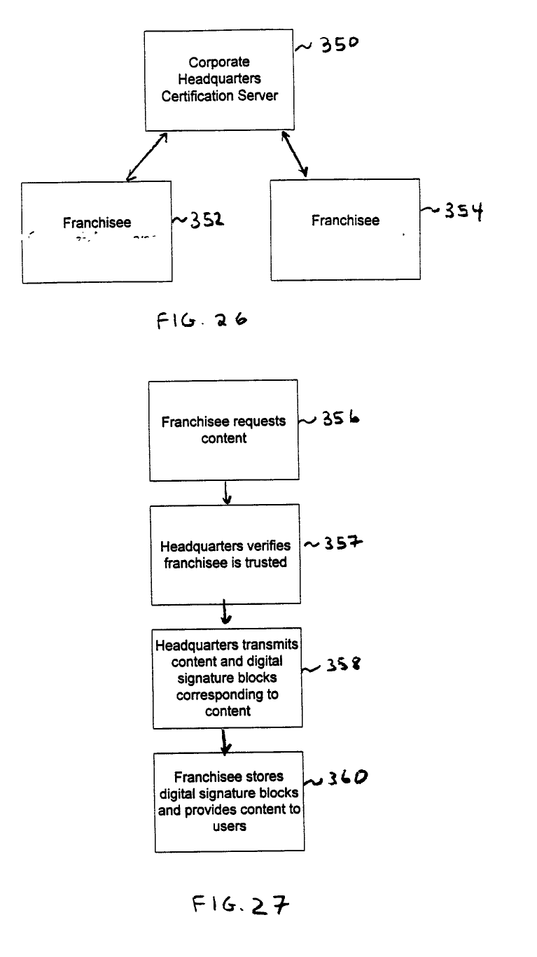

Referring to FIG. 26, a franchisor 350 (e.g., a corporation or syndicate) can provide content to different franchisees 352, 354. Any given site may act as both a franchisee and franchisor (not shown).

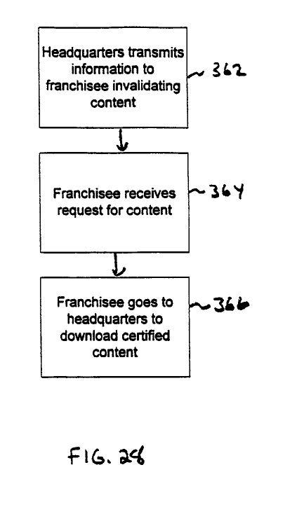

Referring to FIG. 27, after establishing a franchisor/franchisee relationship, a proxy is established at the franchisee with which the franchisor can communicate to manage content including refreshing and invalidating content. Thereafter, a franchisee can request content from the franchisor 356. After authenticating the franchisee's request 357, the franchisor can send the requested content, digital signatures associated with the content, and verification information determined for the content during certification 358. The franchisee can store the downloaded information and provide the content to site visitors 360.

Referring to FIG. 28, a franchisor can control the content offered by its franchisees. For example, to decertify or update content, the franchisor can download replacement content or the franchisor can mark the content in the proxy invalid. When a franchisee receives a request for invalid content 364, the franchisee requests updated content from the franchisor 366. The franchisor can monitor the content offered by its franchisees by examining verification information corresponding to the content or the content itself.

After downloading information from a franchisor to a franchisee Web-server, visitors to the franchisee can view the downloaded content. The franchisee proxy can automatically transmit a certification verification request each time a visitor requests content.

Requests for content can be metered by the franchisee proxy. Thus, a franchisor can receive reports regarding which franchisee sites reached the most customers. Metering data can be used for analytical purposes or even as a way to charge for use of content (e.g., for each web-page hit) or pay for its distribution. For example, metering can be used as a way for franchisees to charge franchisors for distribution of content, for example, by charging a small fee for each content request.

Embodiments

The techniques described here are not limited to any particular hardware or software configuration; they may find applicability in any computing or processing environment. For example, functions described as being performed by a certification server can be distributed across different platforms.

The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program is preferably implemented in a high level procedural or object oriented programming language to communicate with a computer system. however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method of processing content, comprising:
storing verification information corresponding to certified content at a first computer;
receiving a verification request corresponding to content from a second computer;
determining verification information for the content corresponding to the verification request; and
comparing the determined verification information with the stored verification information.

2. The method of claim 1, further comprising, receiving content certification criteria.

3. The method of claim 2, wherein certified content comprises content satisfying the content certification criteria.

4. The method of claim 2, wherein content certification criteria comprises a list of required approval.

5. The method of claim 2, wherein content certification criteria comprises programmed logic.

6. The method of claim 1, further comprising storing certification information.

7. The method of claim 6, wherein certification information comprises at least one of the following: a type of certification granted, entities approving certification, and when the content was certified.

8. The method of claim 1, wherein verification information comprises information derived from the content.

9. The method of claim 8, wherein information derived from the content comprises at least one hash key.

10. The method of claim 1, wherein the verification request includes a URL (Uniform Resource Locator).

11. The method of claim 10, wherein determining verification information comprises collecting content from the URL included in the verification request.

12. The method of claim 1, wherein the verification request includes content.

13. The method of claim 12, wherein determining verification information comprises determining verification information for the content included in the verification request.

14. The method of claim 1, wherein the verification request includes verification information.

15. The method of claim 14, wherein determining verification information comprises using the verification information included in the verification request.

16. The method of claim 1, wherein receiving a verification request comprises receiving a request caused by user interaction with a certification indicator.

17. The method of claim 16, wherein the certification indicator is included in the content.

18. The method of claim 16, wherein the certification indicator comprises a graphic image having associated instructions that produce a verification request.

19. The method of claim 1, further comprising transmitting certification information to the second computer.

20. The method of claim 1, wherein the content comprises at least one of the following: graphics, text, animation, sound, and instructions.

21. The method of claim 1, wherein the content comprises a web-page.

22. The method of claim 1, wherein comparing comprises issuing verification requests to connected certification servers.

23. A method, comprising:
presenting an indication that content has received certification;
receiving user input requesting verification that the content has received the certification indicated;
transmitting a certification verification request to a certification server; and
receiving information describing whether the content has actually received the certification presented by the indication.

24. The method of claim 23, wherein presenting an indication comprises presenting a user interface control.

25. The method of claim 24, wherein receiving user input comprises receiving user input via the user interface control.

26. The method of claim 23, further comprising displaying information included in the information received.

27. The method of claim 23, wherein the information received comprises at least one of the following: content authorship, revision number, expiration date, and type of certification.

28. The method of claim 23, wherein transmitting a certification verification request comprises transmitting verification information determined from the content.

29. The method of claim 28, wherein the verification information comprises a hash key.

30. The method of claim 23, wherein transmitting a certification verification request comprises transmitting information included in the content.

31. The method of claim 23, wherein transmitting a certification verification request comprises transmitting a URL.

32. A method of controlling content distribution, comprising:
receiving certification requirements for content to be distributed;
identifying content to be distributed; and
determining whether the identified content satisfies the received certification requirements.

33. The method of claim 32, wherein identifying content comprises receiving a request for content.

34. The method of claim 32, wherein identifying content comprises collecting content from a set of locations.

35. The method of claim 32, wherein the determining comprises identifying at least one digital signature associated with the content.

36. The method of claim 32, wherein the determining comprises determining verification information for the content.
